(19) United States
(12) Patent Application Publication
(10) Pub. No.: US 2017/0062195 A1
(43) Pub. Date: Mar. 2, 2017

(54) A THERMIONIC ENERGY CONVERSION DEVICE

(71) Applicant: PHILIP JULIAN HARDCASTLE, Glen Innes, New South Wales (AU)

(72) Inventor: PHILIP JULIAN HARDCASTLE, Glen Innes, New South Wales (AU)

(21) Appl. No.: 15/308,474

(22) PCT Filed: May 11, 2015
(86) PCT No.: PCT/IB2015/053437

§ 371 Date: Nov. 2, 2016

(30) Foreign Application Priority Data
May 11, 2014 (AU) 2014901740

(51) Int. Cl. H01J 45/00

(52) U.S. Cl. CPC H01J 45/00

(57) ABSTRACT

There is provided a thermionic energy conversion device (10,11) comprising an emitter (cathode) (5); a collector (anode) (6); an electrical insulator (2) separating the emitter (5) and the collector (6); a negatively charged field inducing layer (4, 3) adapted to induce a field, the field inducing layer (4, 3) arranged distal the emitter (5) with the collector (6) there between, wherein in use, the device (10,11) is heated such that electrons are excited to escape from the emitter (5) towards the field inducing layer; and the electrons are repelled by the field towards the collector (6) for collection by the collector (6), thereby causing the collector (6) to raise in potential with respect to the emitter (5).

### FIELD OF THE INVENTION

The present disclosure relates to a thermionic energy conversion device.

### BACKGROUND

The development of the laws of thermodynamics have sought to fully explain the ability of a source of heat to do work. To this end the steam engine and the Stirling engine are well understood devices: the steam engine using heat to boil water and to use the pressure from the steam to move pistons, and so to output shaft horsepower; and the Stirling engine using heat to cause air or a gas to expand and similarly to use the pressure thus derived to do work against a piston. The Second law of thermodynamics has also been prescriptively applied to all heat to power converter devices, whether or not the device used a working gas such as steam or air. The knowledge of steam engines has led to the adoption of formulas to calculate the limits of efficiency of converting heat into power.

It is a tenet of the Second Law of Thermodynamics that a device using a source of heat to be converted into power cannot be 100% efficient and that as part of the process inevitably some heat must be wasted to a cold sink. Heat engines are thus described as being a device through which heat flows from a hot reservoir to a cold sink and that some of the heat flow is converted to work, the greater the temperature difference between the hot reservoir and cold sink the higher the conversion efficiency, and so sources of thermal energy at temperatures below 300K have little utility for power generation.

The concept of using thermionic electrons to convert heat to power was first proposed by Schlichter in 1915 but it was not until the 1950s that a practical device was made: commonly known as a vacuum diode, or thermionic energy converter. The original vacuum diode device has been studied for decades, and just as with the steam engine and Sterling engine it is a commonly held viewpoint, and one supported by empirical measurement, that the Second Law of Thermodynamics fully describes its operation and therefore prohibits the possibility of efficiency greater than that of the so called Carnot limit.

Conventional thermionic energy converters consist of an electrode, commonly referred to as the cathode, which is connected to a heat source, and another electrode, commonly referred to as the anode, connected to a heat sink and both being separated from each other by a gap, a set of leads connecting the electrodes to the electrical load, and an enclosure that is typically made of a material that is electrically insulating and essentially impervious to gas molecules. The space in the enclosure is either evacuated or filled with a suitable vapour such as caesium. By providing thermal energy to the cathode and thus heating it to a desired operating temperature, whilst cooling the anode so that it remains at a lower temperature than the cathode, surface or near surface electrons gain sufficient kinetic (thermal) energy to overcome the cathode's work function and are able to escape from the cathode and travel to the anode. The electrons absorbed at the anode can then, via leads power an external load and then return to the hot cathode.

Such conventional thermionic energy converters suffer with what is commonly known as the space charge effect. The presence of electrons in the space between the two electrodes creates an additional potential barrier which reduces thermionic current. This limitation detrimentally affects the maximum current density, and thus presents a major problem in developing large scale thermionic converters.

The conventional thermionic converters (vacuum or gas-filled converters) indicated above are used in only a few applications to convert the heat to electrical power as their efficiency has proven to be very poor, and such devices require heating of the cathode to temperatures above 1300K whilst simultaneous cooling the anode in order to prevent the rise in its temperature to above its optimal desired, but lower than the cathode, operating temperature, such cooling being an inherent waste of thermal energy. The high operating temperatures and low efficiency of conventional thermionic converters has made them incapable of low temperature operation, and especially for harnessing thermal energy from sources such as the human body, or waste heat from electronics.

Furthermore, the amount of electrical power produced by currently available conventional thermionic converters is very low in comparison to the cubic volume of the devices, and the efforts and means required. The known prior art devices for converting heat to electric power are not suitable for a many applications which may require high efficiency, high power density, high voltage, and the use of low temperature thermal energy.

The competing facts of heat loss over small electrode spacing and low currents over wide electrode spacing have proven that the conventional thermionic heat to power converters have only minor exotic application and little impact on electricity production.

In the light of aforementioned discussion, there exists a need for a heat to power converter which would overcome these and other shortcomings, or at least ameliorate shortcomings associated with the conventional systems.

It is to be understood that, if any prior art information is referred to herein, such reference does not constitute an admission that the information forms part of the common general knowledge in the art, in Australia or any other country.

### SUMMARY OF THE DISCLOSURE

With the foregoing description of the prior art in the mind, a need therefore exists for an energy conversion device that does not require the electrodes to be at substantially different temperatures. A further need exists for an energy converter not requiring a cold sink such that all or most of the heat is converted to power.

Yet further need exists for the arraying or stacking of such energy converters in series and/or parallel such that thermal energy can be utilised by all of the energy converters and for the ability to increase the voltage (wherein the energy converters are stacked) or the current (wherein energy converters and parallel). Such arrays may be made of energy conversion cells that are both thin, preferably only a few micrometers, and highly thermally conductive.

Further, there exists a need for an efficient low temperature and implantable energy converter at nanometre scales that may include one or more multilayer films with each film containing a unique structure for kinetic energy harvesting of hot free electrons tunnelling from an emitter to a collector, and where the energy converter improves performance, reliability, compactness, utility, and at reduced costs compared to the conventional devices.

Further there exists a need to have a high efficiency and compact heat to power converter, with no thermal exhaust or need for cooling and the ability to accept heat from a wide range of sources, and wherein such device could be used to power individual or multiple loads

Further, there exists a need to have a compact heat to power converter with no requirement for cooling, where it can be easily integrated with the focal target located at the head of a heliostat tower, and with the use therein to at least double the output of the current heliostat without need for additional mirrors

As such, the present disclosure seeks to provide a thermionic energy conversion device, which will overcome or substantially ameliorate at least some of the deficiencies of the prior art, or to at least provide an alternative.

The provided energy conversion device converts heats to electricity by inputting thermal energy into the conversion device and by causing that thermal energy to excite free electrons.

Of greatest significance is that the conversion of thermal energy to electrical power occurs without the need for an exhaust, heat sink or the like and so the efficiency approaches 100%

Specifically, the energy conversion device may isothermally produce electricity from heat by the conversion of hot tail energy electrons emitted from the cathode to an emf, done by hot electrons doing work against an electric field emanating from a layer having a negative charge by contact with a collector layer which has a lower work function. It is understood that when two different metals are brought into contact some essentially unbound electrons will migrate from the lower work function metal, to the higher work function metal, so raising the chemical potential of the higher work function metal, this effect also increases the higher work function metal's negative electrical charge which is seen as being prominent to the surfaces, such a charge acts as an electrostatic reflector. The field inducing layer is caused by the negative charge of the device's metal top plate and the metal sections of its walls.

The cathode in this device is made by depositing a low work function material onto a nickel (or other metal) substrate, the notable property of such being a work function sufficiently low so that at the desired operating temperature a significant number of electrons can escape the surface, the more energetic of these electrons can reach the metal surface of the collector. This metal coating having a lower work function than that of the field inducing layer, but a higher work function than the cathode. The effect of the electric field emanating from the field inducing layer is to suppress secondary and primary electron emissions from the surface of the collector, the suppression causes the collector to rise to a potential higher than would otherwise be possible, and the higher equilibrium results in the device having a voltage difference at the outer surfaces of layers 1 and 4, and as such electrical power can be delivered to an external load.

Envisaged by the application of the device is low cost small or large scale power production, either from direct solar, heat entering into the device at its faces by conduction, or via channels carrying a hot working fluid running through the device volume. The planar design allows for mass production at very low cost with processes somewhat like a modern printing press.

As the devices cells can be stacked it is envisaged that multi layered devices could achieve power output capability of several hundred Watts/cm3. The devices can be used in shallow or deep 3D matrix structures with heat entering into the devices at their faces via channels.

The use of metal and ceramic layers in the device having a maximum dimension of just 1 cm would allow greater and easier thermal energy ingress than that of a device with larger dimensions, and at 1 cm overall size a large mismatch of thermal expansion coefficients between materials and layers can be permitted without serious interlayer alignment issues, however with the use of interlayer bonding larger devices can be made without misalignment occurring

Whilst initial devices may employ cathodes with work functions of more than 1.0 eV, there exists other materials having even lower work functions that would allow the device to operate at very low temperatures by comparison, potentially as low as 273K. With respect to work function it is foreseen that by the application of a negative charge of many kV to the whole of the device, and arrays thereof, the effective work function of the cathodes can be reduced so lowering the temperature of operation at which useful power could be produced.

Due to the small distances between the emitter and collector of the device the need for ultra high vacuum is eliminated, and also space charge effects that limit currents are somewhat negated, to this end future devices may be as thin as 10 um or smaller.

In the embodiment that follow, there will be described the energy converging device in accordance with two primary embodiments.

There are 2 related devices, the first one known as the first embodiment which operates with a vacuum wherein thermionic electrons are caused to do work against an electric field in order to reach an anode, and the other device known as second embodiment operates on a much smaller scale and so has the hot free electrons tunnelling from an emitter and doing work against an electric field in order to appear at a collector.

The first embodiment is best suited to the conversion of high temperature heat to electricity where the ultimate purpose is industrial electricity at prices that are very competitive with other methods of production such as photovoltaic.

The second embodiment is best suited to the generation of power from low temperature energy such as body heat, the term second embodiment referring to Implantable Micro-Power. There exists a vast range of application such as bio-electrical devices such as pacemakers and bionic ears and eyes, or in consumer electronics such as mobile phones where second embodiment would make batteries obsolete.

In both the first and second embodiments the same principles apply, namely the creation of a device allowing hot electron to travel from an emitter/cathode, to a collector/anode, and in so doing convert kinetic energy into electrical potential energy, and at the same time the devices have an electric field that is so shaped as to push electrons towards a central position, even if the electrons emanate from the collector/anode.

The overall effect of the arrangement of charged surfaces, cathodes/emitters, and anode collectors is to create an essentially one way energy sorting diode.

For both devices a key point is that they can be stacked and put into arrays such that they are very compact, and are economical to make and use.

By having the conversion device manufactured as a convenient hand sized tile/biscuit that incorporates multiple devices stacked one on top of the another, and by the ability to arrange the biscuits into an array, and that such an array may yield a very high power densities, typically more than 1 MW per m3.

One aim of the disclosure is to provide new devices for converting heat to electrical power which avoids afore cited drawbacks of the prior art solutions. According to the present disclosure, a more efficient heat into usable electric power converter is made possible by using either the first embodiment ballistic vacuum regime for a variety of applications up to and including industrial scale power generation, or the second embodiment that uses the electron tunnelling quantum effect and which can drive a variety of applications where convenience and solutions is more important than cost per watt.

Another objective of the second embodiment disclosure is to provide a device that, when excited thermally from the heat generated by other electronic devices such as integrated circuits CPUs, thermodynamically cools such electronic devices by generating electrical power that is used externally, or that the generated power is looped back to power the waste heat generating device. In either mode the net effect is to use the device as a method of controlling the temperature of electronic devices that consume power that is converted to heat that is an unwanted and wasteful byproduct of their intended function. This looping may obviate the need for external powering of CPUs, or other applicable devices, and/or obviate the need for CPUs and other applicable devices to be cooled by an internal to external heat exchange process.

These and other objectives, aspects, and advantages of the present subject matter will be better understood with reference to the following description and appended claims. This summary is provided just to introduce the concepts in a simplified form. The summary is not intended to identify key features or essential features of the claimed subject matter, nor is it intended to be used to limit the scope of the claimed subject matter.

As such, with the foregoing in mind, there is provided a thermionic energy conversion device comprising an emitter (cathode); a collector (anode); an electrical insulator separating the emitter and the collector; a negatively charged field inducing layer adapted to induce a field, the field inducing layer arranged distal the emitter with the collector there between, wherein in use, the device may comprise heated such that electrons are excited to escape from the emitter towards the field inducing layer; and the electrons are repelled by the field towards the collector for collection by the collector, thereby causing the collector to raise in potential with respect to the emitter.

The field may further substantially prevent primary or secondary emissions from the surface of the anode.

The field inducing layer and collector may be electrically connected.

The negatively charged field inducing layer may comprise spacers to space at least a portion of the negatively charged field inducing layer away from the collector.

The field inducing layer and the collector may comprise materials having differing work functions so as to have differing energy levels so as to induce the field.

The collector may comprise molybdenum.

The field inducing layer may comprise tungsten.

The emitter may have a work function of 3 eV or less for the first embodiment of the device or 5.1 eV or less for the second embodiment of the device.

The emitter may have a work function such that at even at low temperatures, a substantial amount of electrons can escape the surface of the emitter.

The emitter may comprise a nickel or tungsten substrate

The work function of the collector may comprise greater than that of the emitter.

The work function of the negatively charged field inducing layer may comprise greater than that of the collector.

The negatively charged field inducing layer may be shaped to focus the electrons towards the collector.

At least one of the emitter, collector and field inducing layer may be sealed so as to provide a vacuum.

The thermionic energy conversion device may further comprise an insulator located within the void between at least one of the emitter, collector and field inducing layer.

The device may comprise adapted such that the electrons tunnel through the insulator.

The cathode may comprise nickel.

The insulator may comprise nickel oxide.

The thermionic energy conversion device may further comprise a positive electrical connector electrically connected to the emitter and a negative electrical connector electrically connected to the anode.

The electrical connectors may be adapted to allow the stacking of the device with an adjacent device for increasing at least one of the voltage and current output provided by the combination of the device and the adjacent device.

Other aspects of the disclosure are also disclosed.

### BRIEF DESCRIPTION OF THE DRAWINGS

Notwithstanding any other forms which may fall within the scope of the present disclosure, a preferred embodiments of the disclosure will now be described, by way of example only, with reference to the accompanying drawings in which:

FIG. 1 shows a cross-sectional diagram across the minor axis of an first embodiment of thermionic energy conversion device according to a first preferred embodiment of the present disclosure;

FIG. 2 shows a plan view of layers 1-4 of the device of FIG. 1 in accordance with the first embodiment;

FIG. 3 shows an exploded view of the first embodiment;

FIG. 4 shows a view of an first embodiment with all layers in contact;

FIG. 5 shows a view of the first embodiment device formed by a 3D array of first embodiment cells;

FIG. 6 shows a second preferred embodiment of the present disclosure where the void is now filled with an insulator; and

FIG. 7 shows a cross sectional view of the second embodiment but differing from FIG. 6 in that it represents a form of the device that can be achieved by thin film deposition technologies.

### DESCRIPTION OF EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the structures, systems and associated methods relating to thermionic energy conversion device are disclosed and described, it is to be understood that this disclosure is not limited to the particular configurations, process steps, and materials disclosed herein as such may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

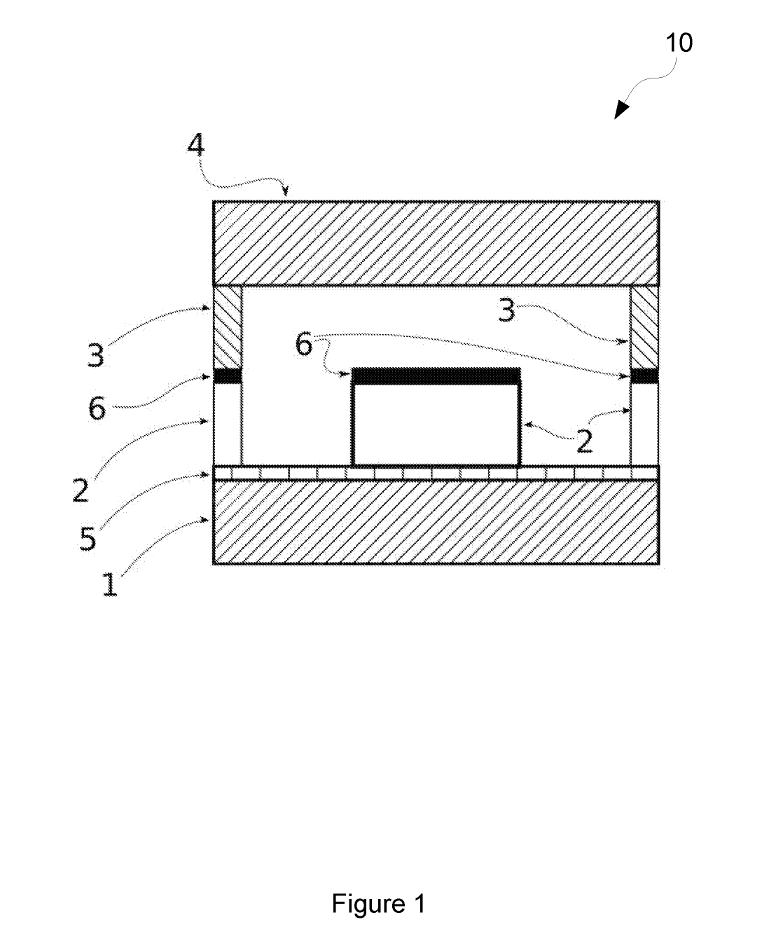

It is to be understood that the present disclosure has at least two preferred embodiments, the first preferred embodiment that shown in FIG. 1 wherein the distance between the Cathode and Anode are typically a few micrometres to a few millimetres, and where the void between the Cathode and Anode have so few gas molecules as to not significantly impede the free motion of electrons within the void, the regulation thereof may require vacuum pumps or even ultra high vacuum systems. In such an embodiment thermionic electrons traverse the gap in a ballistic mode, much like a cannonball does but subject to an electrostatic field rather than a gravitational one.

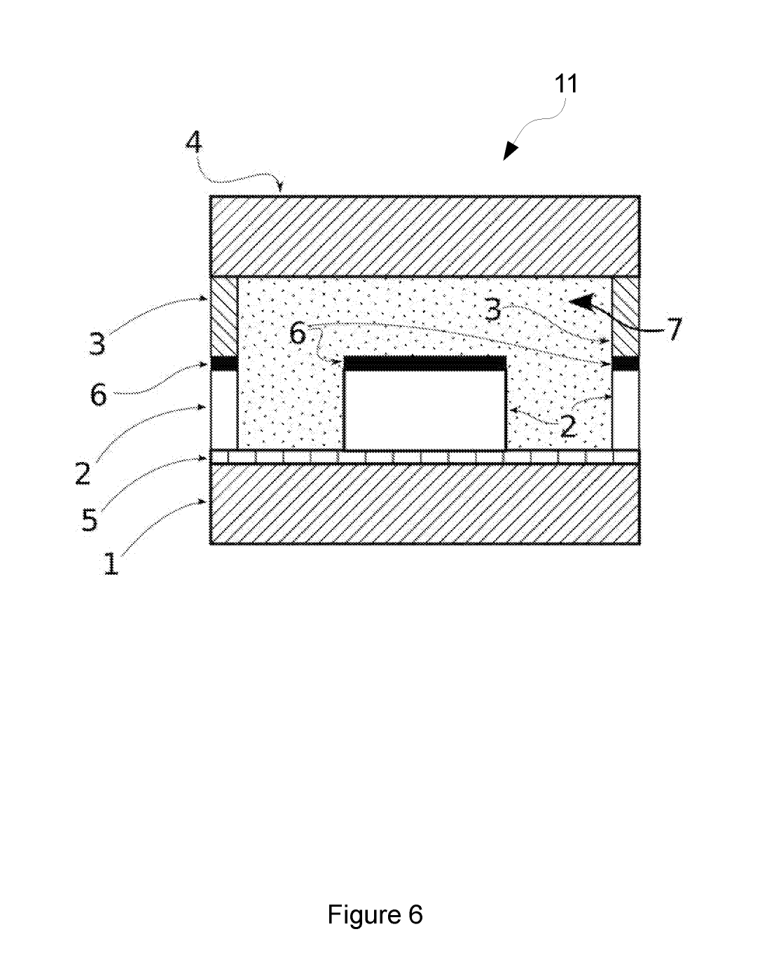

The second preferred embodiment as shown in FIG. 6 has a distance between the Cathode and Anode being of the order of a nano-metre, and where the void of the first preferred embodiment is now filled with an insulator 7. At this scale electrons can go from the Cathode to the Anode by the mechanism of Quantum or electron tunnelling.

It is to be understood that the terms “quantum tunnelling” and “electron tunnelling” are interchangeable and herein are used to describe a phenomenon where electrons cross a potential barrier based on a probability model, despite the fact that in non quantum classical theory electrons should not pass through such as insulator other than by ohmic paths.

It is also accepted that tunnelling electrons behave like a wave, rather than a particle, and for that reason tunnelling is considered to be instantaneous or at least at the speed of light. The quantum tunnelling effect has shown great promise in a number of electronic components like varistors, diodes, and transistor devices. Therefore, it is one of objectives of the proposed disclosure to make use of the quantum tunnelling effect in general terms and electron tunnelling in particular in the present multilayered heat to power conversion device.

Furthermore, the doing of work against an electric field over a short range by thermionically emitted electrons makes the isothermal heat to power converter devices well suited for a variety of relatively high power applications such as electric motor vehicles, home power supply systems, power tools, heating and air cooling, lighting and the like, and for a variety of low power applications such as digital memories, pacemakers, hearing aids, mobile phones, personal computers and computer related accessories etc.

### First Preferred Embodiment

FIG. 1 shows a first embodiment and in particularly a single functional cell thereof, and of particular interest, the various layers or regions constituting the device with reference to numeral 10.

This cell may include a first metallic contact electrode 1, a cathode created by applying a low work function coating 5, an electrical insulator 2, an anode 6 formed directly on insulator 2, a metallic spacer 3, a metallic plate 4 which also act as either the second contact electrode of a single cell 10 or as the first contact electrode for the next cell when stacked.

The void within the cell 10 is required to be essentially a vacuum sufficiently devoid of gas molecules so as not to inhibit or restrict the motion of electrons, such a vacuum is typically created and maintained with a getter pump or gettering materials such as, but not limited to barium.

The bonding of the layers should occur only when all the layers are in dimensional alignment, this requires calibration of the supply components and may involve having the components made with patterns when at a temperature similar to that of the interlayer bonding, that is to say if the pattern of insulator 2 is made at 1300K, then the pattern of the metallic spacer 3 should be created either at 1300K or if done at another temperature, then by calculation of an adjustment of the dimensions so as to match the other components when heated to the interlayer bonding temperature at the 1300K.

The dimension of the cell 10 is ideally as small as practical as electrons travelling from the cathode 5 to the anode 6 are less impeded by the unwanted gas molecules within the void the shorter the path. However the limits to miniaturisation need to be balanced with performance and costs.

The anode 6 should be of a thickness sufficient to conduct a current along its major axis to the point where it comes into contact with the metallic spacer 3, if too thin then the electron flow is so impeded as to cause the collector voltage potential to rise, and this in turn to inhibit electron absorption from the electrons arriving from the cathode 5. On the other hand making the anode 6 too thick has the effect of increasing the area of the sides of the anode 6 such that they become a significant point of leakage of electrons back to the cathode 5.

The first and second contact electrodes 1 and 4, and the metallic spacer 3 are made of a metal that is suitable for the operating temperature of the device, that are essentially corrosion resistant, and have a work function suited to be used in conjunction with the metal of anode 6, such suitable metals include tungsten, molybdenum, rhenium, iron and nickel.

The anode 6 is made of a metal that is suitable for the operating temperature of the device, that is essentially corrosion resistant, and that has the desired work function so as to be used in conjunction with the metal of the metallic spacer 3, such suitable metals include tungsten, molybdenum, rhenium, iron and nickel.

The key consideration in the selection of metals for use as the anode 6 and the metallic spacer 3 and metallic plate 4, is the difference of work functions, if the anode 6 is made of molybdenum, and the metallic spacer 3 and metallic plate 4 are made from tungsten, then when they are in contact the anode 6 transfers such electrical charge to the metallic spacer and metallic plate 4 so as to make them a charged surface of approximately 0.2 eV higher than that of the anode 6, and that such charge creates an electric field to which thermionic electrons emitted from the cathode 5 must do work against to reach the anode 6, therein that combination of metals means that the kinetic energy of the electrons from the cathode 5 is partly converted to electrical potential energy when the electrons reach the surface of the anode 6.

The key to the disclosure is the creation of a form of a one way valve to hotter than average electrons, and an important component of this one way flow is the shape of the charged surface formed by the metallic spacer 3 and the metallic plate 4. As can be understood the negative charge on the metallic plate 4 is the primary mechanism by which thermionic electrons from the cathode 5 must do work against, whilst the charge on the metallic spacer creates a vector component of the electric field of the charged surface that points towards the centre of the anode 6 plateau. The combined effect is that electrons that are sufficiently hotter than the average can escape the cathode 5, climb up the potential gradient of the electric field in the direction of the metallic plate 4 and then as they slow be strongly influenced by the charge on the metallic spacer 3 so as to deflect towards the anode where they then are forced into the anode by the electric filed vector from the metallic plate 4.

Of great importance is the action of the metallic spacer 3 and metallic plate 4 in acting upon any secondary electrons that are caused by the collision with the anode 6 from electrons arriving primarily from the cathode 5. As a metals electrical potential rises so too does its tendency to emit secondary electrons if impacted by a free electron, in the event of a secondary emission, or even a primary thermionic emission from the anode 6 the electrons so emitted are suppressed by the metallic plate 4 so that their path is more than likely to return them to the anode 6, those electrons so emitted and with a significant kinetic component at a slant angle and towards the vertical of the metallic spacer 3 are more likely than not to have insufficient energy to make beyond the edge of the anode 6 and so will tend to fall back to the anode 6 rather than travel to the cathode 5.

As the in this discussion the first embodiment is a form of a diode but of complicated topology, the actual geometries and ratios are subject to re-design to obtain optimal performance for a particular set of operating parameters, as a good starting point is the one shown in FIG. 1, it is essentially is to scale in that the width of the cathode 5 is similar to that of the thickness of the insulator 2, and to that or the metallic spacer 3, and slightly smaller than the width of the exposed anode 6. Other designs can be created with differing geometries if for example voltage is more important than power.

Not shown in any of the diagrams is a means by which the void can be evacuated, this would be a small micro channel and in some cases there may not be a need for such. If the cell is made and bonded under vacuum then the included vacuum may be sufficiently stable so as to not require a channel connecting the void to an external vacuum vessel or pump. If a vacuum maintenance system is to obviated then all materials in constructing the cell 10 must be outgassed by baking in vacuum at least at the desired operating temperature and preferably slightly higher.

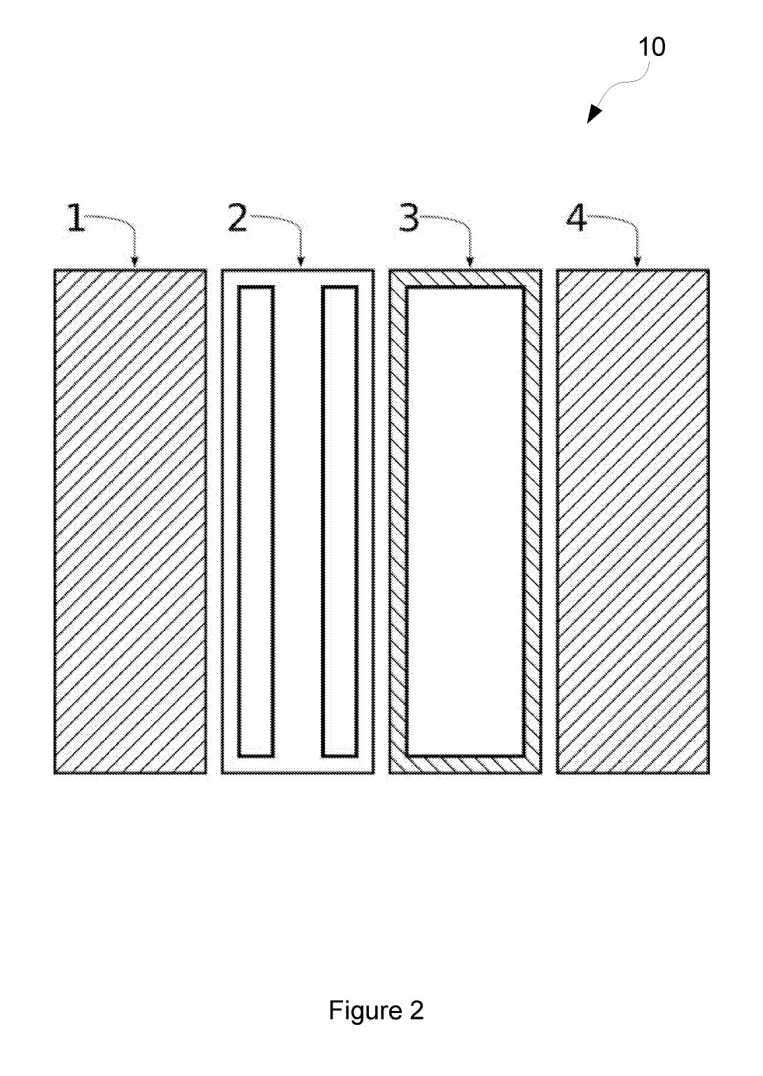

As shown if FIG. 2 the cell 10 can be made of essentially flat parts made of a simple pattern, the metallic plate 1 can be cut from a roll of a suitable metal bare metal or metal that is coated with a suitable cathode material, the insulator 2 can be made by either punching the pattern onto a film of suitable ceramic or from a roll of the ceramic film, and similarly for the metallic spacer 3. The metallic plate 4 and metallic spacer 3 can be made as a single item by hot embossing the pattern onto the suitable metal.

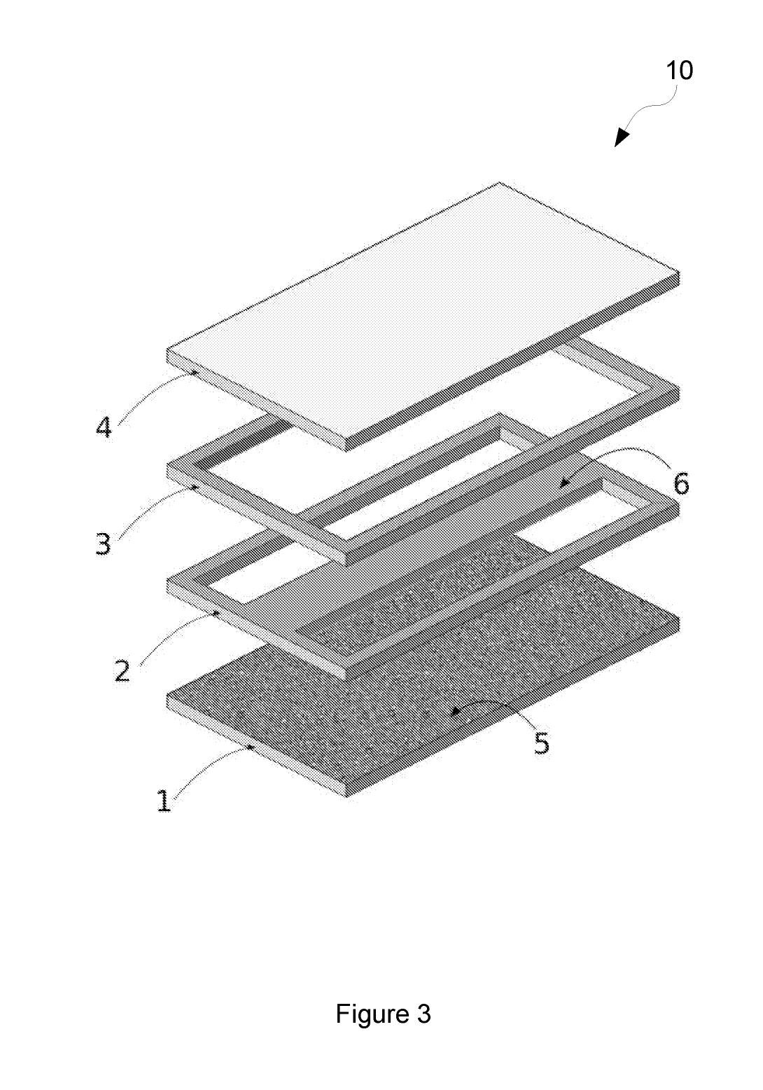

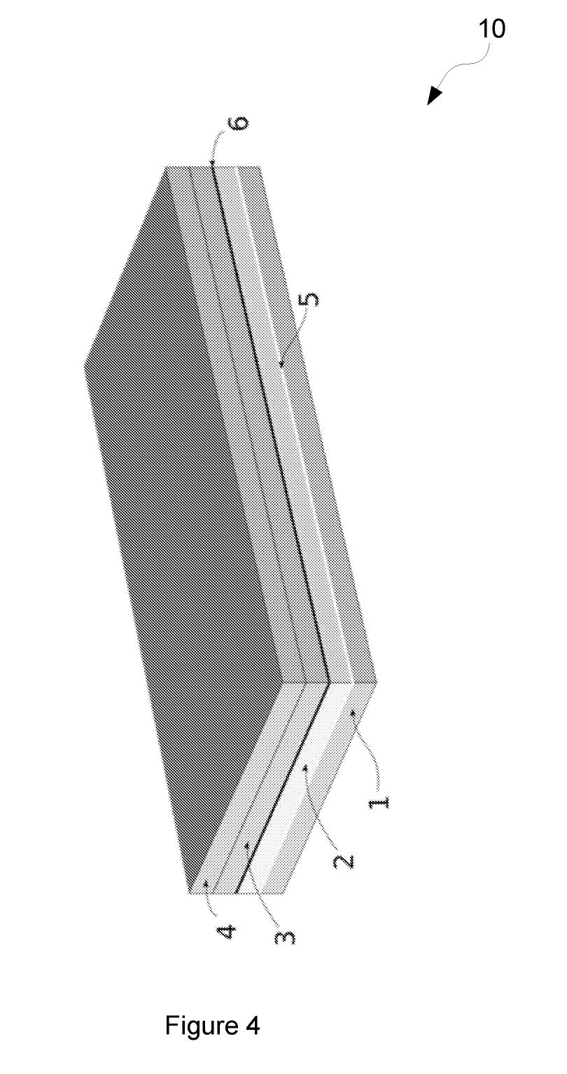

FIG. 3 and FIG. 4 illustrate how the cell 10 components are arranged and bonded into a compact and stackable cell 10.

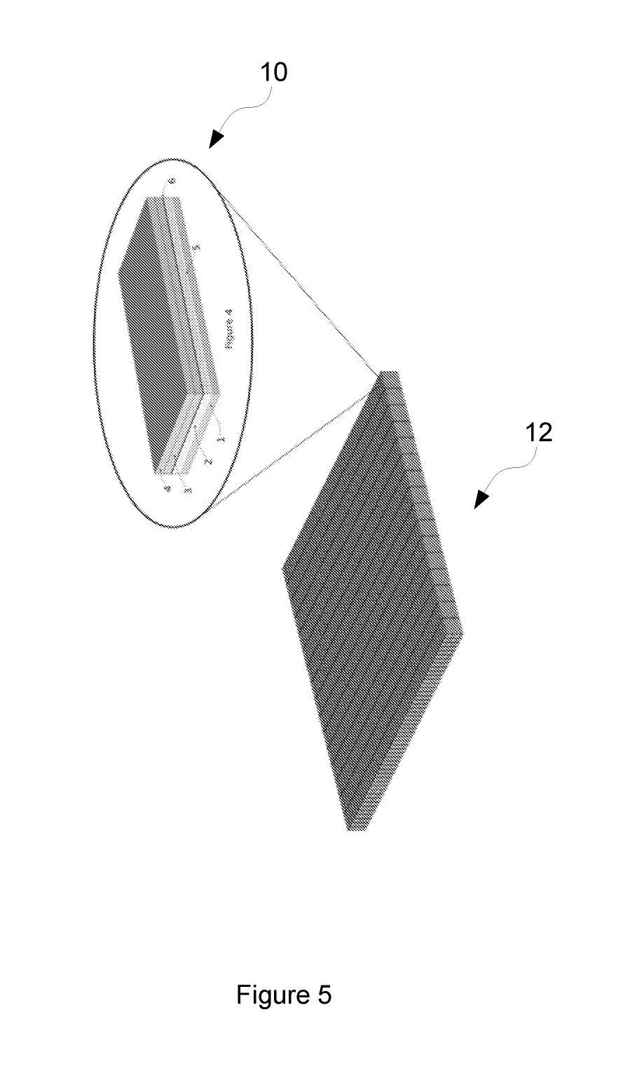

The first embodiment is designed to be compact and stackable and to operate isothermally, the diagram of FIG. 5 shows cells 10 arranged in a 3D array. As the devices at the centre layers of such an array need to receive thermal energy at sufficient rate so as to support their electrical output requirements it is important to consider thermal conductivity of all components, when the cells are operated with the voids at high vacuum the only path for thermal energy is by conduction, such thermal transfer through cells 10 are improved by the intimate bonding of the layers. Further engineering decisions are required to select the insulators which can be the biggest impediment to thermal energy flow. Suitable ceramics should exhibit high electrical resistance but should also have high thermal conductance, a suitable ceramic having such properties can be specified, examples of such suitable ceramics include sapphire and silicon nitride.

The first embodiment cell in its layer form can be in fact multiple cells in a 2D sheet, it is envisaged that if a single cell 10 is 100 um wide by 400 um long then a heated pressed and bonded tile 10 cm×10 cm would incorporate 1,000×250 cells (cell 10) for a total of 250,000 cells. It is further envisaged that using good thermal conductivity through the layers such tiles could be stacked 100 high to produce a biscuit just 1 cm thick and incorporating in total 25 million cells. To make economically such biscuits having massive power conversion capability an automated process is envisaged, this would sensibly include the heating of all films and patterned films to the same temperature which for tungsten, molybdenum and related ceramics could be 1300K, and using optical alignments to bond under pressure the elements and then to repeat and stack a further 100 times. Such a process envisages the production of a biscuit in only minutes of machine time.

### The Second Embodiment

FIG. 6 shows the second embodiment. Of particular interest, the various layers or regions constituting the device with reference to numeral 11 which has all similar shaped components as that of the first embodiment cell 10, but at a much reduced dimension, and in addition it has a region 7 made out of a suitable electrical insulator where the cell 10 there was a void capable of being a evacuated to vacuum.

The operating temperature of the second embodiment, whilst it could be designed to operate at high temperatures, is primarily intended to be much lower than that of first embodiment because of its niche applications made possible by the alternate mechanism by which the electrons go from the cathode 5 to the anode 6. In second embodiment electrons quantum tunnel through the insulator 7 and as such the relevant factors for an electron to escape the cathode 5 to arrive at the anode 6 is the potential barrier at the interfaces of 5 and 7, and 7 and 6.

Using, for example, nickel as a cathode and nickel oxide as the insulator 7 it is known that the barrier height is as low as 0.2 eV. At such a low barrier height there is the capability of extreme current flow from the emitter to the collector even when they are at only 310K (body heat).

With reference to FIG. 6, the total current generated by the second embodiment is not only a function of the barrier height at the emitter 5 and second insulator junction, but also with reference to the size of the electric field electrons must climb and the barrier height at the junction of the second insulator and the collector 6. If the combination of barrier heights are low enough, the electric field small enough, and the tunnelling distance is short enough then the probability of an electron getting from the cathode to the anode can be high enough to constitute a useful electrical current, in some case this would likely exceed 10 ampere per cm2 of cathode area. However for many applications required currents may only be milliamperes per cm2.

In the circumstance that the current needed is only micro amperes the use of a single layers of cells 11 may be sufficient for an output voltage of 0.5V, however in most uses a single cell at required current will produce only 0.1V and so stacks of up to 15 layers will be required for powering external device. However it is to be understood that the total thickness of the second embodiment cell is measured in nanometers and so even a stack of 1,000 layers would only be about Sum thick. As such care needs to be exercised in the use of second embodiment stacks as high voltages relative to thickness can be generated and so ohmic leakage paths can easily occur, edges should be duly coated with electrical insulating coatings.

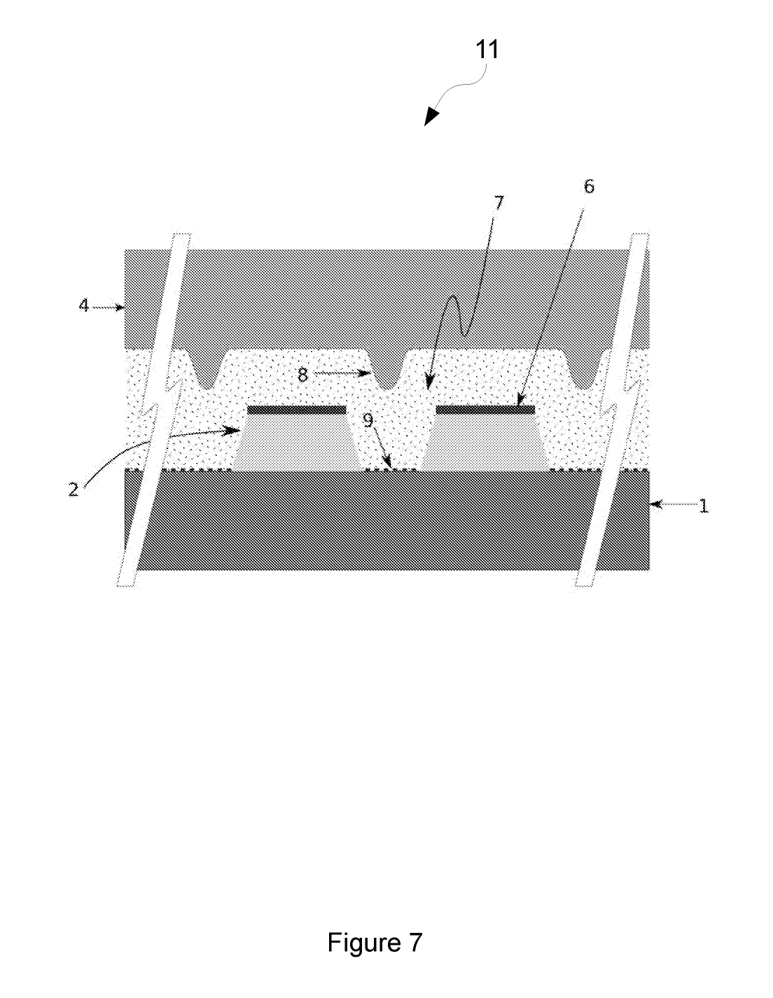

With reference to FIG. 7, shown is an achievable form of the IMP, in this diagram the emitter is 9, the first contact plate 1 may in some cases be the same as the emitter 9. Also shown are insulators 2 and 7, the essential difference is that insulator 2 must be an electrical insulator to all electrons, whereas insulator 7 is so selected to facilitate electron tunnelling from the emitter 9 to the collector 6.

The insulator 2 can be made of any suitable high electrical resistance ceramic, an example of such is sapphire.

The insulator 7 can be made of a suitable insulator having the dual function of forming low potential barriers at the junction with the emitter 9 and the collector 6, and of having good thermal conductivity, examples of such insulators are nickel oxide when used in conjunction with nickel as the emitter 9, and hafnium oxide when used in conjunction with hafnium at the emitter 9.

As illustrated in FIG. 7 one noteworthy feature of the second embodiment is the formation of a hanging protrusion 8 into the insulator 7, this as part of the second connecting electrode is intended to form a charged surface that has the same function as the metallic spacer 3 and metallic plate 4 of the first embodiment, except that in second embodiment electrons do not per se travel through the insulator 7 but leave the emitter 9 and almost instantaneously arrive at the collector 6, and though whilst the description of electrons in an first embodiment cell 10 are not the same the effect of the charged surfaces of both are essentially identical, for the second embodiment electron that tunnel from the emitter 9 and arrive at the collector 6 have lost kinetic energy and gained electrical potential energy, and electrons tunnelling from the collector 6 tend to almost instantaneously reappear at some other point of collector 6. As such the second embodiment has the same tendency to act as a ratchet to hot electrons as does the first embodiment.

Further, and with reference to the illustration of FIG. 7, the preferred path length for electrons tunnelling from emitter 9 to collector 6 will be no more than 1.5 nm, the gap between the collector 7 and the underside of the second electrical connector 4 should be similar to the geometry as shown though some modifications might be considered if the work function of the second electrical connector is much more than 0.2 eV higher than the collector 6.

The method of production for the second embodiment illustrated by FIG. 7 comprises (assuming that the first contact electrode is atomically smooth) if required by the choice of materials, coat the emitter 1 with a suitable emitter; coat a layer of the first insulator 2; metallise the surface of the first insulator, either by adding a metal, or by converting the top surface of the oxide to metal using a heated hydrogen gas flow, for example if Al₂O₃ is used then the surface can be converted to metallic Aluminium under a hydrogen flow; by such method as is available, include nano patterning, e-beam milling, etching and others, removed parts of the first insulator and collector to expose again the emitter; using a conformal coating process such as ALD add the second insulator 2, this will leave a dip over the areas where the first insulator 2 and anode 6 were removed; add a coating of the second contact electrode.

Further to the stepwise construction of the second embodiment there needs to be point so contact or near contact, less than 0.5 nm, so the generated electrical power can leave the second embodiment and so that the second electrode 4 can be charged by electron diffusion from collector 6 which is has a lower work function the second contact electrode. Such contact points must regularly occur along the major axis of the device in order that collector does not create such a potential gradients as to suppress operation. These long axis contact points will require other patterning, milling and etching processes which a person skilled in the art will understand.

Whilst second embodiment is ultra-thin the size of an actual device may be large as the processes such as ALD can just as easily coat 10 cm2 as 1 mm2. The total power produced by the second embodiment is a function of the effective emitter area, when trenches around the emitter 9 are very wide then only the closest nm to the first insulator and anode 6 plateau come into play, therefore it is preferable to have the pattern as tight as possible for maximum power, in general such process as e-beam can produce patterns but will take literally days to make a cm2 of effective emitter, nano patterning may make in a few minute-hours a wafer sized pattern, and alternatively a crude method of scratching using rows of single point diamond or other tip materials, could produce the desired emitter area in seconds.

The use of ALD is clearly applicable for prototype second embodiment but it desirable to use low costs methods, and as such non vacuum processes are preferred, these may include wet chemistry and as such combined with crude scratching an industrial process would be the preferred method of producing the second preferred embodiment.

As will be appreciated from the foregoing description, the proposed first and second embodiment heat to power converter devices have the advantageous feature that they can efficiently convert thermal energy to electricity that can then drive any electrical load.

The present disclosure in its first preferred embodiment focuses on layers, regions and void constituting the device 10, and their properties which help meet the objectives and advantageous features of the disclosure, especially the metallic spacer and plate layers acting as charged surface that both coverts a kinetic electrons energy into potential energy and creates a preferential path thus making the divide a form of energy ratchet, and in the interaction of the anode with the metallic spacer and metallic plate to generate an auto biasing of the charged surface such that the device needs no external control or electrical regulation.

The first embodiment offers a unique opportunity to retro-fit existing heat to power conversion technologies in such applications as heliostat mirror fields where the solar energy is concentrated and focussed on a target. As first embodiment needs no cooling it can readily be put at the focal point and then connected to the electrical distribution system, and as the first embodiment is far more efficient the total output of the retro-fitted heliostat could at least double and in so doing improve profitability dramatically.

The device of the second embodiment 11, has the advantage in that it can produce electrical power from a wide range of heat sources, including body heat. If converting body heat it can be used as an implanted device to power things such as pacemakers, bionic ears and eyes, and many other bio-electrical devices or systems.

Furthermore the second embodiment device of 11 can be used in consumer electronics such as phones wherein the phone never needs to be charged in order to operate, thus the second embodiment can reduce environmental damage by obviating the need for batteries and there subsequent disposal.

The device 11 has the capability of being produced at high yield namely be mass-produced at extremely low cost, this opens the way to the industrial utilization of the first embodiment heat to power converter device 11. Those skilled in the art will understand that under nano-fabrication facilities, various available techniques may be used to produce multilayer thin films of the present disclosure, the techniques preferably includes but not by the way of any limitation Atomic Layer Deposition, Physical Vapor Deposition, Chemical Vapor Deposition, and the like.

Patterned surfaces of emitters and insulators can be prepared by nano printing and nano-patterning techniques, or even by simple scratch based processes.

The various layers of device 11 can be made using self-organising and limiting organic materials in other than laboratory processes, and thus potentially making second embodiment a product that requires little capital investment and low industrial capability.

Having thus described various exemplary embodiments of the disclosure, it will be understood by those skilled in the art that modifications or changes in details of the disclosure may be implemented without departing from the spirit and scope of the disclosure as defined in the following claims.

With the foregoing in mind, there are now provided various exemplary embodiments of thermionic energy conversion device. It should be noted that these embodiments are exemplary only and that no technical limitation should necessarily be imputed to the other embodiments described herein accordingly.

In accordance with the first exemplary embodiment, there is provided a device that isothermally convert heat into electrical power.

In accordance with a second exemplary embodiment, there is provided a device having a thermal energy input surfaces; a pair of electrical power output surfaces; there is no thermal exhaust or intended thermal energy path from the device that would constitute a waste of thermal energy; the capability of being stacked one upon the other to form higher voltage, and put into arrays to form higher voltage and higher power capabilities in a compact form.

In accordance with a third exemplary embodiment, there is provided a device wherein electrons having kinetic energies significantly higher than the average do work against an electric field and as such convert their kinetic energy into electrical potential energy, and wherein the electrical potential energy is capable of being output as electrical power.

In accordance with a fourth exemplary embodiment, there is provided a device that isothermally converts heat into electrical power, the device comprising one or more cells, wherein the device has, when operating, thermionic electrons traversing an internal vacuum, and wherein each of the cell comprising; a first contact electrode made of a metal that is corrosion resistant and does not melt or decompose at the operating temperature of the device, examples of such metals include tungsten for operating temperatures up to 2000K, and nickel for operating temperatures up to 1200K; a cathode deposited upon, or bonded to, or lying directly upon the first contact electrode, and having a sufficiently low work function coating such that it emits a useful amount of electrons at the operating temperatures of the device, examples of such coatings include LaB6, CeB6 for operating temperatures up to 2000K, and a tungsten matrix doped with mixtures of metal oxides such as barium and scandium for operating temperatures up to 1400K, for lower temperatures there exists a wide choice of known materials including Ag.O.Cs for use down to room temperatures; an electrical insulator that does not melt or decompose at the operating temperature of the device, such insulators include alumina, silicon nitride and sapphire; an anode made of a metal that is corrosion resistant and does not melt or decompose at the operating temperatures of the device, and wherein it has a slightly lower work function than the metal of the metallic spacer listed here next, examples of such metals include iron where the metallic spacer is made of nickel, and molybdenum where the metallic spacer is made of tungsten; a metallic spacer made of a metal that is corrosion resistant and does not melt or decompose at the operating temperatures of the device, examples of such metals include nickel for operating temperatures up to 1200K, and tungsten for operating temperatures up to 2000K; a metallic plate made of identical metal to that of the metallic spacer; a second contact electrode made of a metal that is corrosion resistant and does not melt or decompose at the operating temperatures of the device, examples of such metals include tungsten for operating temperature up to 2000K, and nickel for operating temperatures up to 1200K; a void within the cell and primarily being the volume between the cathode and anode, wherein the void is so evacuated so as to be a vacuum, which thermionic electrons can travel through with little impediment to their path from gas molecules, or if the distance between the cathode and anode are small enough to be a partial vacuum, or even at atmospheric pressure provided that the probability of electrons travelling through the void colliding with the gas molecules is suitably low enough and a micro sized channel venting the cell void to an external containment vessel, which may itself be evacuated to the extent that gas molecules can escape the cell void and so enable the proper operation of the cell.

In accordance with a fourth exemplary embodiment, there is provided a device wherein the metallic spacer and the metallic plate are in contact with each other and are both negatively charged relative to the anode, and where the parts together form a shaped charged surface whose inner surface is of the form of an inverted cup with vertical sides and a horizontal top.

In accordance with a sixth exemplary embodiment, there is provided a device wherein the formed charged surface has the effect of acting upon electrons thermionically emitter from the cathode in the following manner; to cause the thermionic electrons to lose kinetic energy as they move up the gradient of the electric potentials of the electric field emanating from the charged surface and, if they have sufficient energy to climb the electric field to electrical potentials potential levels greater than that of the anode to then to deflect those electrons sideways, away from the closest vertical charged surface and towards the anode, and then downward until they collide with the anode; to cause the electrons emitted from the cathode that arrive at the anode to have lost kinetic energy, and so to have cooled significantly from when they were at the cathode; to cause those electrons to have reached the anode to then induce in the anode an increased electrical potential as the electrons are in effect pushed by the negative charged surfaces in the direction of and into the anode; to cause electrons to lose kinetic energy and to convert that energy in to electrical potential energy and ultimately to cause the anode to become so negatively charged that it is capable of providing useful electrical power to an external load.

In accordance with a seventh exemplary embodiment, there is provided a device wherein the formed negative charged surface has the effect of acting upon electrons either thermionically emitted by the anode or secondary electrons emitted by the anode as a result of collisions upon the anode by thermionic electrons that came from the cathode in the following manner; to reduce the number of electrons that are thermionically emitted from the anode; to inhibit the path of such electrons that are thermionically emitted from the anode by having vectors of the surface charge induced electric field being directed towards the centre of the anode, notably the sideways component of the electric field being primarily as a consequence of the vertical parts of the charged surface; to reduce the number of secondary electron emissions emitted from the anode; to inhibit the path of such secondary electrons that are emitted by the anode by having vectors of the surface charge induced electric field being directed towards the centre of the anode, notably the sideways component of the electric field being primarily as a consequence of the vertical parts of the charged surface.

In accordance with an eighth exemplary embodiment there is provided a device wherein the electrons that are absorbed by the anode are able to traverse the anode along its long axis until they reach an area where there is contact with the metallic spacer.

In accordance with an ninth exemplary embodiment there is provided a device wherein electrons that are absorbed by the anode and traverse to, and transfer across by diffusion to the metallic spacer, then increase the electrical potential of the metallic spacer and the metallic plate, and wherein the charged surface becomes more negatively charged and so increases the size of the electric field that thermionic electrons from the cathode must do work against to reach the anode, and in so doing the device output voltage increases if no current is drawn.

In accordance with an tenth exemplary embodiment there is provided a device wherein the auto adjusting bias of the charged surface permits the engineering of optimal device power density by matching electrical loads to the devices characteristics, maximum power density being at a point where the current and voltage product of the device are maximum and this is achieved by the sizing of the load.

In accordance with a further exemplary embodiment there is provided a device wherein the cells are able to be formed into an array and where the metallic plate can be coated by a cathode coating and so reduce the number of parts to three.

In accordance with a further exemplary embodiment there is provided a device wherein the layers can under heat and pressure be sinter bonded ensuring that the critical alignment of the layers is maintained irrespective of the temperature or any thermal expansion mismatch between the layers.

In accordance with a further exemplary embodiment there is provided a device wherein the bonding of the layers ensures that thermal energy can effectively penetrate an array of device cells as there is a continuous conductive path.

In accordance with a further exemplary embodiment there is provided a device that isothermally converts heat into electrical power, the device comprising one or more cells, wherein it has, when operating, electrons tunnelling through an included insulator, and wherein each of the cell comprising; a first contact electrode made of a metal that is corrosion resistant and does not melt or decompose at the operating temperature of the device, examples of such metals include tungsten, molybdenum, hafnium and nickel for operating temperatures up to 1200K, and gold and silver up to operating temperatures of up to 800K; an emitter deposited directly upon the first contact electrode, wherein the emitter is made of a metal that may be the same as that of the first contact electrode, or of a different metal including one from the group of tungsten, molybdenum, hafnium, nickel, gold and silver; a first electrical insulator deposited directly upon the emitter as a continuous layer and which, after it has been coated with the metal, is removed in specific locations so as to form the desired pattern, and wherein the first electrical insulator has a suitable electron affinity such that in combination with the metal of the emitter there is no significant electron tunnelling through the thickness of the insulator, an example of such an insulator includes sapphire deposited on nickel for operating temperatures up to 1200K, for low operating temperatures, including room temperature, insulators may include some stable organic materials that in combination with the emitter metal would facilitate significant electron tunnelling through the thickness of the insulator, and example of which may include polycarbonate; a collector deposited directly upon the first insulator, wherein the metal of the collector in combination with the second insulator forms a barrier height sufficiently low to permit electron tunnelling through the second insulator to reach the collector, an example of a suitable metal may include iron, aluminium, gold and molybdenum; a second electrical insulator deposited directly upon the emitter and directly upon the first insulator, and wherein by careful selection of the materials there is formed between the second insulator and the emitter an interface, and wherein the barrier height to tunnelling electrons is suitably low enough for the device, at its operating temperature, to exhibit a useful flow of electrons from the emitter, through the second insulator, to the collector, and wherein examples of such combinations include nickel emitter interfacing with nickel oxide second insulator, and a hafnium emitter interfacing with hafnium oxide second insulator; a second contact electrode made of a metal with a higher work function than the collector, and wherein the second contact electrode is in direct contact with the collector at certain points, and wherein by electron diffusion from the collector to the second contact electrode an electric field is created with a gradient from the second contact electrode, through the second insulator, and to the emitter, and wherein as a consequence thereof the tunnelling electrons from the emitter must do work in order to appear at the collector and periodic regions where the collector comes into contact with the second contact electrode so forming an electrical path and, because the metals are dissimilar, a mechanism to electrically negatively bias the second contact electrode.

In accordance with a further exemplary embodiment there is provided a device wherein the thickness of the second insulator is of the order of 0.5-2 nanometer so that the tunnelling current from the emitter to the collector is significant, the thickness of the second insulator being a key parameter in the probability of any given electron being able to tunnel, the thinner the more likely.

In accordance with a further exemplary embodiment there is provided a device wherein the second insulator formed by deposition on top of the first insulator and the emitter has a shape where it conforms to the underlying topology, the effect being that there is a lobe that protrudes partly into the gap between the first insulator pattern.

In accordance with a further exemplary embodiment there is provided a device wherein the protrusion being filled with the metallic second contact electrode thus forms a convoluted surface across the device.

In accordance with a further exemplary embodiment there is provided a device wherein the convoluted surface when negatively charged acts upon electrons at the emitter in the following ways; to inhibit the tunnelling of all but the most energetic of the free surface electrons from the emitter to the collector; to cause such electrons that have sufficient kinetic energies as to tunnel from the emitter, through the second insulator, and to the collector, to lose kinetic energy by interaction doing work against the charged surface, and in so doing increase their electrical potential energy; to make the only significantly probable end point of the tunnelling to be on the collector as the surface has a lateral electric field vector component.

In accordance with a further exemplary embodiment there is provided a device wherein the convoluted surface when negatively charged acts upon electrons at the collector in the following ways;

To increase their electrical potential energy and so induce a voltage in the collector;

To inhibit the probability of electrons tunnelling from the collector to the emitter;

To cause such electrons as tunnel from the collector, whether as a high energy surface or near surface electron, or from an electron so excited by interaction with an electron that has tunnelled from the emitter, otherwise typically known as a secondary electron, to exit the secondary insulator back at the collector in preference to the emitter.

In accordance with a further exemplary embodiment there is provided a device wherein because the construction of the device is done by deposition in solid layers there is no need for the collector to have any connections across the minor axis, and it is sufficient for there to be periodic points along the collector surface where the second contact electrode comes into contact with the collector for the purpose of transferring accumulated electron charge from the collector to the second contact electrode.

In accordance with a further exemplary embodiment there is provided a device wherein the contact points between the collector and the second contact electrode should be as brief as possible with the thickness of the second insulator thinned for as little area as possible.

In accordance with a further exemplary embodiment there is provided a device wherein as an alternative to actual contact between the collector and second contact electrode, the second insulator thickness is reduced to 0.5 nm, or less, thus allowing electron tunnelling to be highly probable for almost all electron energies.

In accordance with a further exemplary embodiment there is provided a device wherein the metallic spacer and the metallic plate are formed as a single component.

In accordance with a further exemplary embodiment there is provided a device wherein if cells are stacked one upon another the metallic top plate of one cell could simultaneously be used as the first contact electrode of the next stacked cell, thus reducing the number of components in a stacked array.

In accordance with a further exemplary embodiment there is provided a device wherein by applying a negative charge to the whole device item 10 the effective work function of the cathode may be reduced.

### Interpretation

### Embodiments

Reference throughout this specification to “one embodiment” or “an embodiment” means that a particular feature, structure or characteristic described in connection with the embodiment is included in at least one embodiment of the present disclosure. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the disclosure, various features of the disclosure are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed disclosure requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those in the art. For example, in the following claims, any of the claimed embodiments can be used in any combination.

Different Instances of Objects

As Used Herein, Unless Otherwise Specified the Use of the Ordinal Adjectives “First”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the disclosure may be practiced without these specific details. In other instances, well-known methods, structures and techniques have not been shown in detail in order not to obscure an understanding of this description.

### Terminology

In describing the preferred embodiment of the disclosure illustrated in the drawings, specific terminology will be resorted to for the sake of clarity. However, the disclosure is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the disclosure, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the disclosure.

Any one of the terms: including or which includes or that includes as used herein is also an open term that also means including at least the elements/features that follow the term, but not excluding others. Thus, including is synonymous with and means comprising.

### SCOPE OF INVENTION

Thus, while there has been described what are believed to be the preferred embodiments of the disclosure, those skilled in the art will recognize that other and further modifications may be made thereto without departing from the spirit of the disclosure, and it is intended to claim all such changes and modifications as fall within the scope of the disclosure. For example, any formulas given above are merely representative of procedures that may be used. Functionality may be added or deleted from the block diagrams and operations may be interchanged among functional blocks. Steps may be added or deleted to methods described within the scope of the present disclosure.

Although the disclosure has been described with reference to specific examples, it will be appreciated by those skilled in the art that the disclosure may be embodied in many other forms.

1. A thermionic energy conversion device comprising:
an emitter (cathode);
a collector (anode);
an electrical insulator separating the emitter and the collector;
a negatively charged field inducing layer adapted to induce a field, the field inducing layer arranged distal the emitter with the collector there between, wherein in use, the device is heated such that:
electrons are excited to escape from the emitter towards the field inducing layer; and
the electrons are repelled by the field towards the collector for collection by the collector, thereby causing the collector to raise in potential with respect to the emitter.

2. A thermionic energy conversion device as claimed in claim 1, wherein the field further substantially prevents primary or secondary emissions from the surface of the collector.

3. A thermionic energy conversion device as claimed in claim 1, wherein the field inducing layer and collector are electrically connected.

4. A thermionic energy conversion device as claimed in claim 3, wherein the negatively charged field inducing layer comprises spacers to space at least a portion of the negatively charged field inducing layer away from the collector.

5. A thermionic energy conversion device as claimed in claim 1, wherein the field inducing layer has a higher work function than that of the collector so as to cause the field inducing layer to become negatively charged and so induce the field.

6. A thermionic energy conversion device as claimed in claim 5, wherein the collector comprises molybdenum.

7. A thermionic energy conversion device as claimed in claim 5, wherein the field inducing layer comprise tungsten.

8. A thermionic energy conversion device as claimed in claim 1, wherein the emitter has a work function comprising at least one of a work function less than 3 eV and a work function less than 5.1 eV.

9. A thermionic energy conversion device as claimed in claim 1, wherein the emitter has a work function such that, in use, a substantial amount of electrons can escape the surface of the emitter.

10. A thermionic energy conversion device as claimed in claim 1, wherein the emitter comprises a nickel substrate.

11. A thermionic energy conversion device as claimed in claim 1, wherein the work function of the collector is greater than that of the emitter.

12. A thermionic energy conversion device as claimed in claim 11, wherein the work function of the negatively charged field inducing layer is greater than that of the collector.

13. A thermionic energy conversion device as claimed in claim 1, wherein the negatively charged field inducing layer is shaped to focus the electrons towards the collector.

14. A thermionic energy conversion device as claimed in claim 1, wherein at least one of the emitter, collector and field inducing layer are sealed so as to provide a vacuum.

15. A thermionic energy conversion device as claimed in claim 1, further comprising an insulator located within the void between at least one of the emitter, collector and field inducing layer.

16. A thermionic energy conversion device as claimed in claim 15, wherein device is adapted such that the electrons tunnel through the insulator.

17. A thermionic energy conversion device as claimed in claim 15, wherein the cathode comprises nickel.

18. A thermionic energy conversion device as claimed in claim 17, wherein the insulator comprises nickel oxide.

19. A thermionic energy conversion device as claimed in claim 1, further comprising a positive electrical connector electrically connected to the emitter and a negative electrical connector electrically connected to the anode.

20. A thermionic energy conversion device as claimed in claim 19, wherein the electrical connectors are adapted to allow the stacking of the device with at least one adjacent device for increasing at least one of the voltage and current output provided by the combination of the device and the adjacent device.
